(19) United States
(12) Patent Application Publication
(10) Pub. No.: US 2024/0149348 A1
(43) Pub. Date: May 9, 2024

(54) ALSIMGMN ALLOY FOR ADDITIVE MANUFACTURING

(71) Applicant: UNIVERSITE DU QUEBEC A CHICOUTIMI, Chicoutimi (CA)

(72) Inventors: Paul Arthur Rometsch, Chicoutimi (CA); X-Grant Chen, Saguenay (CA); Esmaeil Pourkhorshid, Chicoutimi (CA)

(21) Appl. No.: 18/505,416

(22) Filed: Nov. 9, 2023

Related U.S. Application Data
(60) Provisional application No. 63/382,953, filed on Nov. 9, 2022.

(51) Int. Cl. B22F 10/28; B22F 10/64; C22C 21/02

(52) U.S. Cl. CPC B22F 10/28; B22F 10/64; C22C 21/02; B33Y 10/00

(57) ABSTRACT

There is provided an additive manufacturing process. An aluminum alloy is deposited layer by layer from powder or wire feedstock, the aluminum alloy comprising Si, Fe, Ti, 0.3-1 wt. % of Mn and 0.3-1 wt. % of Mg. A thermal consolidation is then performed to obtain a manufactured product.

### CROSS-REFERENCE TO RELATED APPLICATION

This application is a non-provisional of, and claims priority to, U.S. Provisional Application No. 63/382,953, filed Nov. 9, 2022, which is incorporated herein by reference in its entirety.

### TECHNICAL FIELD

This disclosure relates to the field of additive manufacturing and alloys for additive manufacturing, more particularly selective laser melting.

### BACKGROUND OF THE ART

Selective laser melting (SLM) is an additive manufacture (AM) process that has been used to produce metal parts with a complex geometry in a near-net-shape manner. The number of aluminum alloys that can be processed by AM is limited to alloys which can tolerate the challenges of the rapid solidification nature of AM, such as alloys of the Al—Si system. However, the mechanical properties of current Al—Si alloys have had limited strength when used in SLM. Currently, Al—Si—Mg feedstocks near the eutectic point are mostly utilized to build crack-free components with high performance. The microstructure determines the mechanical properties of SLM specimens and the microstructure is impacted by the rapid solidification in the SLM process.

A common problem in all fusion-based AM, such as SLM, is that many aluminium alloys are prone to cracking upon solidification. As a result, eutectic-based aluminium foundry alloys with good castability and fluidity (e.g. AlSi10Mg and AlSi7Mg alloys) have been favoured and used most widely for AM because they resist cracking and offer good printability. Unfortunately, such alloys are known to only achieve mediocre strengths, with yield strengths rarely exceeding 300 MPa. In addition to all these issues, one of the major challenges for high strength alloys is in relation to printability and associated defects such as hot tearing. Therefore, there remains a need for improvements in the composition of Al—Si alloys for SLM and other AM processes in order to obtain improved performance and mechanical properties, including an improved strength (e.g. more than 300 MPa yield strength) with good printability (e.g. avoiding cracking in the microstructure).

### SUMMARY

There is provided an additive manufacturing process comprising: depositing layer by layer an aluminum alloy from powder or wire feedstock, the aluminum alloy comprising Si, Fe, Ti, 0.3-1 wt. % of Mn and 0.3-1 wt. % of Mg, and performing a thermal consolidation to obtain a manufactured product. In some embodiments, the aluminum alloy further comprises 6 to 13 wt. % of Si. In some embodiments, the aluminum alloy further comprises 0.04-0.5 wt. % Fe. In some embodiments, the aluminum alloy further comprises less than or equal to 0.2 wt. % Ti. In some embodiments, thermal consolidation includes the melting of each layer as it is deposited by a laser to perform a laser powder bed fusion. In some embodiments, the additive manufacturing process further comprises heat treating the manufactured product. In some embodiments, the additive manufacturing process further comprises aging the manufactured product. In some embodiments, the heat treating is a T5 or a T6 treatment. In some embodiments, the T5 treatment is performed for 0.4 to 20 h at temperatures of 150 to 190° C. In some embodiments, the T5 treatment is performed for 0.5 to 8 h at a temperature of 150 to 190° C. In some embodiments, the additive manufacturing process further comprises a stress relief treatment for 0.5-8 h at a temperature of 200-400° C. In some embodiments, the additive manufacturing process further comprises a T6 treatment comprising a first heat treatment at 450-600° C. for 0.1-10 h followed by a second heat treatment of 0.4 to 20 h at 150 to 190° C. The T6 treatment can comprise a cooling step in between the two heat treatments, for example a water quench. In some embodiments, first the stress relief treatment is performed, then the T6 treatment. In some embodiments, the aluminum alloy is provided with the balance being aluminum and inevitable impurities, and the total inevitable impurities is less than or equal to 0.30 wt. %. In some embodiments, the aluminum alloy comprises less than 0.1 wt. % Cu. In some embodiments, the aluminum alloy comprises less than 0.05 wt. % Ni. In some embodiments, the aluminum alloy comprises Si in the range of 9.5 to 11.5 wt. %. In some embodiments, the aluminum alloy comprises Mg in the range of 0.3 to 0.6 wt. %. In some embodiments, the aluminum alloy comprises Mn in the range of 0.3 to 0.6 wt. %.

Many further features and combinations thereof concerning the present improvements will appear to those skilled in the art following a reading of the instant disclosure.

### DESCRIPTION OF THE DRAWINGS

FIG. 1 is a plot of yield strength against silicon content for Al—Si casting alloys made by SLM, with nominal powder compositions and tempers shown in the legend. Different tempers are represented by different symbols: triangles for the as-fabricated condition (F), circles for solution treated and aged conditions (T6), squares for solution treated and naturally aged conditions (T4), diamonds for directly aged conditions (T5), and crosses for annealed conditions (O). The vertical dotted lines show typical yield strength ranges for the common F357, AlSi10Mg and AlSi12 alloys in different tempers. This figure is prior art and is taken from P. A. Rometsch, Y. Zhu, X. Wu et al., Review of high-strength aluminium alloys for additive manufacturing by laser powder bed fusion, Materials & Design 219 (2022) 110779.

FIG. 2A is a schematic showing the tensile test coupons printed per SLM build.

FIG. 2B is a graph of the porosity in function of the volumetric energy density (VED) calculated by: laser power/(laser speed×hatch distance×layer thickness).

FIG. 2C is a metallography of point labelled “A” on the graph of FIG. 2B.

FIG. 2D is a metallography of point labelled “B” on the graph of FIG. 2B.

FIG. 3A is a schematic showing the laser remelting process.

FIG. 3B is a graph showing the AlSiMgMn hardness as a function of aging time at different temperatures after laser scan or SLM.

FIG. 3C is a microscopy image showing the AlSiMgMn melt pools from laser scan trials conducted on cast plates.

FIG. 3D is a microscopy image showing the AlSiMgMn melt pools from the SLM trials.

FIG. 4A is a bar graph of the yield strength (YS) comparing AlSiMgMn and AlSi10Mg.

FIG. 4B is a bar graph of the ultimate tensile strength (UTS) comparing AlSiMgMn and AlSi10Mg.

FIG. 4C is a bar graph of the elongation to fracture (E or Elong.) comparing AlSiMgMn and AlSi10Mg.

FIG. 5A is a graph showing the stress-strain curves for SLM and high pressure die casting (HPDC) samples.

FIG. 5B is a bar graph showing the strength and the Si in the matrix of SLM and HPDC samples.

FIG. 6A is a microscopy image showing the microstructure of a sample obtained with HPDC.

FIG. 6B is a magnification of FIG. 6A.

FIG. 6C is a microscopy image showing the microstructure of a sample obtained with SLM.

FIG. 6D is a magnification of FIG. 6C.

FIG. 7A is a graph showing the aspect ratio of the SLM as-manufactured grains.

FIG. 7B is a graph showing the grain size of the SLM as-manufactured grains.

FIG. 8A is a microscopy image showing the eutectic structure of AlSiMgMn alloy as-manufactured (SLM).

FIG. 8B is a microscopy image of the alloy of FIG. 8A after a T5 treatment.

FIG. 8C is a microscopy image of the alloy of FIG. 8A after a T6 treatment.

FIG. 9A is a transmission electron microscopy image showing the eutectic structure of AlSiMgMn alloy as-manufactured (SLM).

FIG. 9B is a transmission electron microscopy image of the alloy of FIG. 9A after a T5 treatment.

FIG. 9C is a transmission electron microscopy image of the alloy of FIG. 9A after a T6 treatment.

FIG. 10A is an electron backscatter diffraction (EBSD) showing the microstructure of an AlSi10Mg alloy as-manufactured.

FIG. 10B is a scanning electron microscopy (SEM) on the sample of FIG. 10A.

FIG. 10C is a SEM close up of the area in the square in FIG. 10B.

FIG. 10D is an electron backscatter diffraction (EBSD) showing the microstructure of an AlSi10Mg0.5Mn alloy as-manufactured.

FIG. 10E is a SEM on the sample of FIG. 10D.

FIG. 10F is a SEM close up of the area in the square in FIG. 10E.

FIG. 11A is a SEM of the AlSi10Mg alloy after a T5 temperature treatment.

FIG. 11B is a SEM of the AlSi10Mg0.5Mn alloy after a T5 temperature treatment.

FIG. 12A is a SEM of the AlSi10Mg alloy after a T6 temperature treatment.

FIG. 12B is a SEM of the AlSi10Mg0.5Mn alloy after a T6 temperature treatment.

FIG. 13A is a transmission electron microscopy (TEM) image of the AlSi10Mg alloy as manufactured.

FIG. 13B is a TEM of the AlSi10Mg0.5Mn alloy as manufactured.

FIG. 13C is a TEM of the AlSi10Mg alloy after a T5 temperature treatment.

FIG. 13D is a TEM of the AlSi10Mg0.5Mn alloy after a T5 temperature treatment.

FIG. 13E is a TEM of the AlSi10Mg alloy after a T6 temperature treatment.

FIG. 13F is a TEM of the AlSi10Mg0.5Mn alloy after a T6 temperature treatment.

### DETAILED DESCRIPTION

Additive manufacturing, or 3D-printing, refers to the layer-by-layer deposition of material to build three-dimensional structures directly from computer-aided design (CAD) files. Compared to traditional ‘subtractive’ manufacturing, this can lead to significant reductions in lead-times, cost and waste for the fabrication of complex bespoke parts, especially for small production runs of highly complex geometries. One example of additive manufacturing is SLM which is also known as laser powder bed fusion (LPBF) or powder bed fusion—laser beam (PBF-LB). Other examples include laser metal deposition (LMD) and directed energy deposition (DED) via blown powder or wire feeding wherein a powder or wire is melted by an energy source such as a laser and deposited layer-by-layer to build a component. Still other examples could include wire arc additive manufacturing (WAAM), binder jetting or any 3D printing method that can utilise aluminium alloy feedstock in wire or powder forms.

Additive manufacturing (AM) in the context of the present disclosure refers to the 3D printing of a component via the layer-by-layer deposition of an aluminium alloy as described above. Some forms of AM such as binder-jetting do not involve repeated melting and rapid solidification, although the powder feedstock is still rapidly solidified. For fusion-based AM, the printing is achieved by means of repeated melting and rapid solidification. Rapid solidification in the context of the present disclosure refers to solidification cooling rates of about 10³ to 10⁷ K/s. There is provided a printable AlSiMgMn alloy that can achieve a 30% higher yield strength when compared to a standard AlSi10Mg alloy, because of the addition of Mn as an alloying element to increase the strength obtained. Accordingly, there is provided, in some embodiments, an aluminium alloy comprising or consisting of, in weight percent, Si in the range of 6 to 13, Fe in the range of 0.04 to 0.5, Cu less than 0.1 or less than 0.05, Mn in the range of 0.3 to 1, Mg in the range of 0.3 to 1, and Ti less than or equal to 0.2 or less than or equal to 0.1. This alloy is easily producible in high quality spherical powders, can be printed at high speed without harmful defects and has improved mechanical properties and stress relieving properties after post-processing.

Si is provided in the range of 6 to 13 wt. % because Si provides the eutectic which allows for improved castability and printability in additive manufacturing, as well as Si in solution and/or in precipitates for improved strengthening. If the Si content is too low, for example below 6 wt. %, then the printability and strengthening ability of the alloy will be significantly reduced, preventing the formation of a complex manufactured product with high strength. If the Si content is too high, for example more than 13 wt. %, then there is a risk of forming large primary Si particles (beyond the eutectic point), which can decrease the ductility and strength. In some embodiments, the alloy of the present disclosure comprises Si, in weight percent, from 6.5 to 13, from 7 to 13, from 7.5 to 13, from 8 to 13, from 8.5 to 13, from 9 to 13, from 9.5 to 13, from 6.5 to 12.5, from 6.5 to 12, from 6.5 to 11.5, from 7 to 12.5, from 8 to 12, from 9 to 11.5, from 9.6 to 11.5, from 9.7 to 11.5, from 9.8 to 11.5, from 9.9 to 11.5, from 10.0 to 11.5, from 9.5 to 11.4, from 9.5 to 11.3, from 9.5 to 11.2, from 9.5 to 11.1, from 9.5 to 11.0, from 9.5 to 10.9, from 9.5 to 10.8, from 9.5 to 10.7, from 9.6 to 11.4, from 9.7 to 11.2, from 9.8 to 11.0, from 9.9 to 10.9, or from 10.0 to 10.7.

The Mg is provided in the range of 0.3 to 1 wt. % so that sufficient Mg is provided to the formation of MgSi hardening precipitates during ageing treatment. Depending on the temper, the Mg can also provide more solid solution strengthening. A minimal amount of Mg of 0.3 wt. is needed to obtain the desired properties and MgSi hardening precipitates. However, Mg has a high vapor pressure and evaporates rapidly during laser melting. This can result in possible issues related to solute losses, vapour plumes, spatter, reduced printability, porosity and exacerbated cracking, although some of these can be adjusted for and controlled to some extent. Considering that some Mg is lost during the laser melting process, the feedstock materials should contain some extra Mg to compensate for such losses during AM. On the other hand, if the Mg content is too high, it can also result in the loss of Mg to coarse Mg₂Si precipitates, which will decrease the ductility and strength of the resulting alloy. Accordingly, no more than 1 wt. % Mg is added to limit or avoid such disadvantages. In some embodiments, the alloy of the present disclosure comprises Mg, in weight percent, from 0.3 to 0.95, from 0.3 to 0.9, from 0.3 to 0.85, from 0.3 to 0.8, from 0.3 to 0.75, from 0.3 to 0.7, from 0.3 to 0.65, from 0.35 to 0.75, from 0.32 to 0.6, from 0.34 to 0.6, from 0.36 to 0.6, from 0.38 to 0.6, from 0.4 to 0.6, from 0.41 to 0.6, from 0.42 to 0.6, from 0.3 to 0.59, from 0.3 to 0.58, from 0.3 to 0.57, from 0.3 to 0.56, from 0.38 to 0.58, from 0.4 to 0.57, or from 0.42 to 0.56.

The alloy is characterized by the addition of Mn as an alloying element in the range of 0.3 to 1 wt. %. Due to the more rapid solidification rate in AM compared to die casting, the addition of extra Mn allows a further strengthening increment to be achieved via solid solution strengthening and/or the precipitation of Mn-containing dispersoids upon appropriate heat treatment. Mn-containing dispersoids can also form in or around the laser-induced melt pools and pin the grain boundaries, thereby controlling the size of the grains and contributing to extra grain size strengthening. If the Mn content is too high, then there is a risk of forming coarse AlSiMn(Fe) intermetallic particles that can decrease the ductility in some tempers. In some embodiments, the alloy of the present disclosure comprises Mn, in weight percent, from 0.3 to 0.95, from 0.3 to 0.9, from 0.3 to 0.85, from 0.3 to 0.8, from 0.3 to 0.75, from 0.3 to 0.7, from 0.3 to 0.65, from 0.35 to 0.75, from 0.4 to 0.75, from 0.45 to 0.75, from 0.32 to 0.59, from 0.34 to 0.58, from 0.36 to 0.57, from 0.38 to 0.56, from 0.40 to 0.55, from 0.42 to 0.54, from 0.44 to 0.53, from 0.46 to 0.52 or from 0.48 to 0.51.

The alloy contains Fe in the range of 0.04 to 0.5 wt. %. Due to the more rapid solidification rate in AM compared to die casting, more Fe can be placed into solid solution and/or precipitated out into fine dispersoid particles to provide an extra strengthening increment. In some heat treatment conditions (e.g. T6), a low Fe content (e.g. ≤0.15) is preferred to avoid the formation of coarse elongated Fe-phase particles that can decrease the ductility. In tempers without an extra high temperature post-treatment (e.g. T5) a higher Fe content (e.g. ≥0.15) is beneficial for the mechanical properties as coarse Fe-phase particles will not form. In some embodiments, the alloy of the present disclosure comprises in weight percent from 0.10 to 0.45, from 0.10 to 0.4, from 0.10 to 0.35, from 0.10 to 0.30, from 0.15 to 0.5, from 0.20 to 0.5, from 0.15 to 0.31, from 0.19 to 0.31 or from 0.15 to 0.20.

The weight percentage concentration for the aluminum alloy are provided with the balance being aluminum and inevitable impurities. In some embodiments, each of the inevitable impurity is present at a maximum of 0.1 (and in some embodiments 0.05) and the total inevitable impurities comprise less than or equal to 0.30. In some embodiments, it is to be understood herein that the term “inevitable impurity” means that there was no deliberate addition of the recited element.

In some embodiments, the alloy contains less than or equal to 0.2 wt. % Ti, preferably less than or equal to 0.1 wt. %, preferably less than 0.05 wt. % and more preferably less than 0.03 wt. %. Too much Ti can result in Ti-rich particles or clusters that could deteriorate the ductility of the alloy. On the other hand, a small Ti addition is useful for grain refinement purposes so as to reduce the risk of very coarse grains. Therefore, in some embodiment, a minimum amount of Ti is present, for example at least 0.004 wt. %, at least 0.005 wt. %, or at least 0.01 wt. %. In some embodiments, a grain refiner or a reinforcement nanoparticle such as TiB₂, TiC, TiN, Al₃Ta, or LaB₆ can be included in order to improve the resulting strength by promoting grain refinement and combatting cracking.

In some embodiments, Cu is an impurity and is present in a concentration of less than 0.1 wt. %, less than 0.05 wt. %, preferably less than 0.03 wt. %. In further embodiments, Ni is an impurity and is present in a concentration of less than 0.05 wt. %, preferably less than 0.03 wt. %.

The additive manufacturing process of the present disclosure comprises but is not limited to depositing layer by layer the aluminum alloy described herein in powder form and melting each layer as it is deposited using a laser to perform a laser powder bed fusion. In non-limitative embodiments, the laser power used may be from 200 to 400 W, from 250 to 370 W, or from 300 to 370 W. In non-limitative embodiments, the laser speed may be varied from 500 to 3000 mm/s. In some embodiments, the thickness of the layers deposited are from 0.01 to 0.06 mm, from 0.02 to 0.04 mm or 0.03 mm. In some embodiments, the hatch distance is from 0.10 to 0.15 mm, for example 0.13 mm. The laser spot size can be from 0.050 to 0.150 mm. These parameters may be varied depending on the size and complexity of the specific part being manufactured.

Following manufacturing, the obtained manufactured product is preferably heat treated with a T5 or a T6 treatment and/or aged. In some embodiments, a stress relief treatment can be performed after manufacturing for 1.5-2.5 h at a temperature of 250-350° C. In some embodiments, a T5 treatment is performed for 0.4 to 20 h at temperatures of 150 to 190° C. The T5 heat treatment is preferably performed for 0.5 to 8 h at a temperature of 150 to 190° C., preferably 150 to 180° C., more preferably 160 to 170° C. In some embodiments, a T6 treatment is performed with an initial treatment at 450-600° C. for 0.1-10 h, 0.1-1 h or 0.4-0.6 h, followed by cooling (e.g. water quenching (WQ), or quenching with polyethylene glycol, oil, or air/water spray), then optional aging for 20-28 h at room temperature, followed by a final treatment of 0.4 to 20 h or 5 to 7 h at temperature of from 150 to 190° C. or from 150 to 180° C. Room temperature can be defined as 15-30° C. or 20-25° C. In some embodiments, the T6 treatment is performed after a stress relief treatment is performed. In general, faster quenching tends to give higher strength, however, in some cases slower quenching can reduce the risk of cracking and distortion due to quench-induced residual stresses.

### EXAMPLE

The AlSi10Mg Material Data Sheet (EOS Gmbh) indicates that a standard AlSi10Mg alloy (with 9-11 wt % Si and 0.25-0.45 wt % Mg) can achieve T6 tensile properties of 250-260 MPa yield strength, 310-320 MPa ultimate tensile strength and 11% elongation to fracture after SLM on an EOS M290 machine with a 30 μm powder layer thickness. When the SLM is done on a larger machine with a bigger powder layer thickness, some deterioration in these properties can be expected. These properties are based on the following post-SLM T6 heat treatment developed by EOS: solution treating for 30 minutes at 530° C., followed by water quenching, followed by artificial ageing for 6 hours at 165° C.

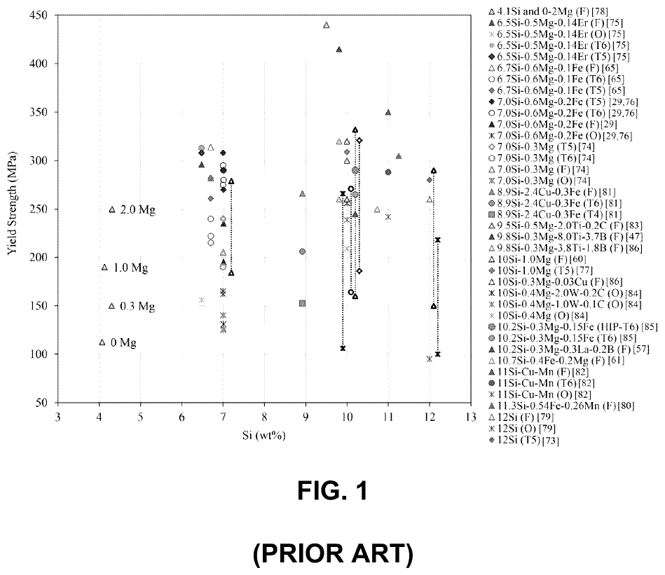

FIG. 1 obtained from P. A. Rometsch, Y. Zhu, X. Wu et al., Review of high-strength aluminium alloys for additive manufacturing by laser powder bed fusion, Materials & Design 219 (2022) 110779, confirms that most AlSiMg-based alloys typically have yield strengths in the range of about 150-300 MPa. Only a few AlSi10Mg alloys can achieve 300-330 MPa in the as-fabricated (F) or directly aged (T5) tempers. In the solution treated and aged condition (T6) it is more common to see properties that are closer to those of castings, with yield strengths in the range of about 170-270 MPa. The only AlSiMg-based alloys with even higher F-temper yield strengths of 415 and 440 MPa in FIG. 1 contain significant additions of 100 nm TiB₂ particles and 30-50 nm TiC particles, respectively. However, unlike standard AlSiMg alloys, such nano-composite alloys tend to require special powder preparation treatments (e.g. blending and ball milling), and it is also not clear how they respond to stress relieving and/or solution treatments.

Preliminary investigations were performed before conducting a full SLM trial that requires sufficient powder to build tensile coupons. The preliminary tests involved an accelerated test where the AlSiMgMn (Table 1) alloy was cast into small plate-shaped samples with a relatively rapid solidification cooling rate. The plates were then ground smooth/flat and placed inside the SLM Solutions 125 machine for laser scanning trials. These trials were designed to create laser-induced melt pools on the surface of the cast plates to achieve similarly rapid solidification conditions as in normal SLM. The laser scanned plates were then sectioned and heat treated to study the melt pools by means of microscopy and hardness testing. The results revealed an as-laser remelted hardness of up to 170 HV, compared to ˜105 HV for the as-cast plate. After a stress-relieving treatment of 2 hours at 300° C., the hardness was still up to 140 HV. This was the first indication that AlSiMgMn can achieve a high hardness without any cracks after simulated laser melting.

TABLE 1
AlSiMgMn composition

| Alloy | Si | Fe | Cu | Mn | Mg | Cr | Ni | Zn | Ti | Sr |
|---|---|---|---|---|---|---|---|---|---|---|
| AlSiMgMn | 9.5- | 0.15- | ≤0.02 | 0.30- | 0.30- | — | — | ≤0.03 | ≤0.10 | ≤0.03 |
| | 11.5 | 0.20 | | 0.60 | 0.60 | | | | | |

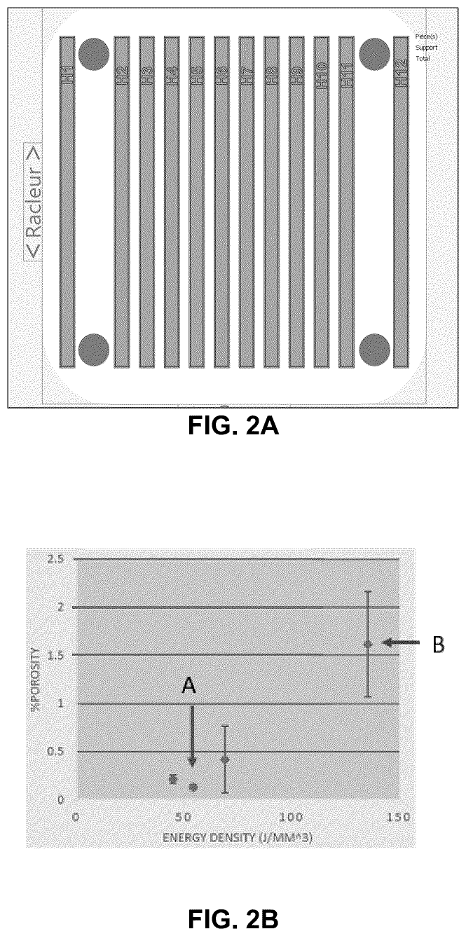

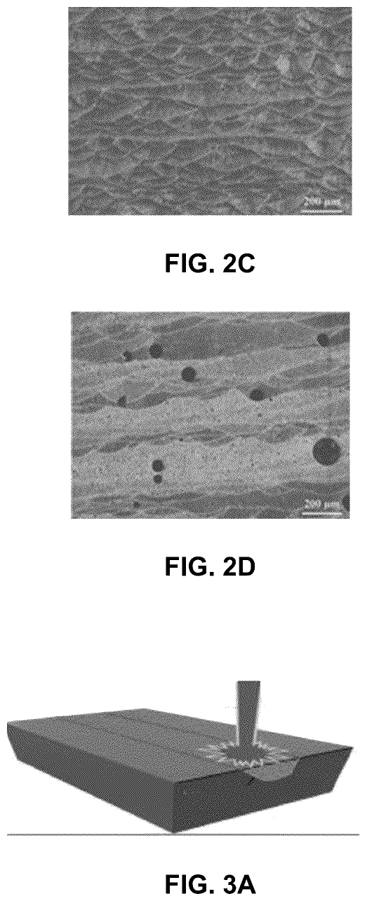

The chemical compositions of all the AlSiMgMn materials evaluated in the present example are provided in Table 2 along with the composition of the standard AlSi10Mg that was used for comparison in the full SLM trial. An objective of the experiment was to enable a direct comparison of mechanical properties between the AlSiMgMn and a standard AlSi10Mg alloy. The SLM print parameters for the full SLM trial where tensile test coupons were fabricated are shown in FIG. 2A. The additional porosity results in FIG. 2B show that AlSiMgMn achieves the lowest porosity and no cracks with the printing parameters recommended for standard AlSi10Mg alloys by the machine supplier SLM Solutions (i.e. VED-ii=54.4 J/mm³). In other words, the printability of the AlSiMgMn composition is virtually the same as that of standard AlSi10Mg alloys.

TABLE 2
Chemical compositions of all AlSi10Mg-based materials used in this work (wt. %)

| Alloy & Form/Use | Si | Fe | Mn | Mg | Ni | Ti | Sr |
|---|---|---|---|---|---|---|---|
| AlSiMgMn casting for laser scanning | 10.4 | 0.2 | 0.51 | 0.56 | — | 0.05 | 0.011 |
| trials | | | | | | | |
| AlSiMgMn ingots used for gas | 10.0 | 0.19 | 0.51 | 0.53 | 0.00 | 0.04 | 0.012 |
| atomization | | | | | | | |
| AlSiMgMn powder P1 | 10.3 | 0.20 | 0.49 | 0.53 | 0.048 | 0.051 | 0.010 |
| AlSiMgMn powder P2 | 10.7 | 0.19 | 0.51 | 0.55 | 0.027 | 0.053 | 0.011 |
| AlSiMgMn after SLM from P1 (lowest | 10.8 | 0.23 | 0.51 | 0.50 | 0.175 | 0.060 | 0.009 |
| porosity) | | | | | | | |
| AlSiMgMn after SLM from P2 (lowest | 10.3 | 0.31 | 0.48 | 0.49 | 0.046 | 0.055 | 0.009 |
| porosity) | | | | | | | |
| AlSiMgMn after SLM from P2 (highest | 10.7 | 0.20 | 0.49 | 0.42 | 0.061 | 0.058 | 0.009 |
| porosity) | | | | | | | |
| Standard AlSi10Mg powder made by | 9.9 | 0.14 | <0.005 | 0.31 | <0.005 | 0.006 | <0.01 |
| plasma atomization | | | | | | | |
| Standard AlSi10Mg after SLM | 10.2 | 0.14 | 0.003 | 0.28 | 0.004 | 0.029 | 0.011 |

FIG. 2A shows the experimental plan for the full SLM trial, showing how 12 tensile test coupons were printed per build. The samples were horizontally oriented with dimensions of 4 mm wide×12 mm high×100 mm long. The machine used was a SLM Solutions 125 and the alloy used was AlSiMgMn. A 67° laser scan direction rotation was used between build layers comprised of a 30 μm powder layer thickness. A metallographic investigation (Table 3 and FIGS. 2B-2D) revealed that the lowest porosity for AlSiMgMn was achieved with the print parameters recommended for AlSi10Mg by SLM Solutions. The same experimental plan was used for the full SLM trials for both gas atomized AlSiMgMn powder and for standard plasma atomized AlSi10Mg powder (FIG. 2B).

TABLE 3
LPBF parameters

| | | | | |
|---|---|---|---|---|
| Laser Power (W) | 350 | 350 | 350 | 370 |
| Laser Speed (mm/s) | 1650 | 2000 | 1300 | 700 |
| Powder Layer Thickness | 0.03 | 0.03 | 0.03 | 0.03 |
| (mm) | | | | |
| Hatch distance (mm) | 0.13 | 0.13 | 0.13 | 0.13 |
| Laser spot size (mm) | 0.062 | 0.062 | 0.062 | 0.100 |
| VED_i (J/mm³) | 114.0 | 94.1 | 144.7 | 176.2 |
| VED_ii (J/mm³) | 54.4 | 44.9 | 69.0 | 135.5 |
| AED (J/mm²) | 1.63 | 1.35 | 2.07 | 4.07 |
| Number of samples in | 12 | — | — | — |
| the first build | | | | |
| Number of samples in | 3 | 3 | 3 | 3 |
| the second build | | | | |
| Number of samples in | 6 | 2 | 2 | 2 |
| the third build | | | | |

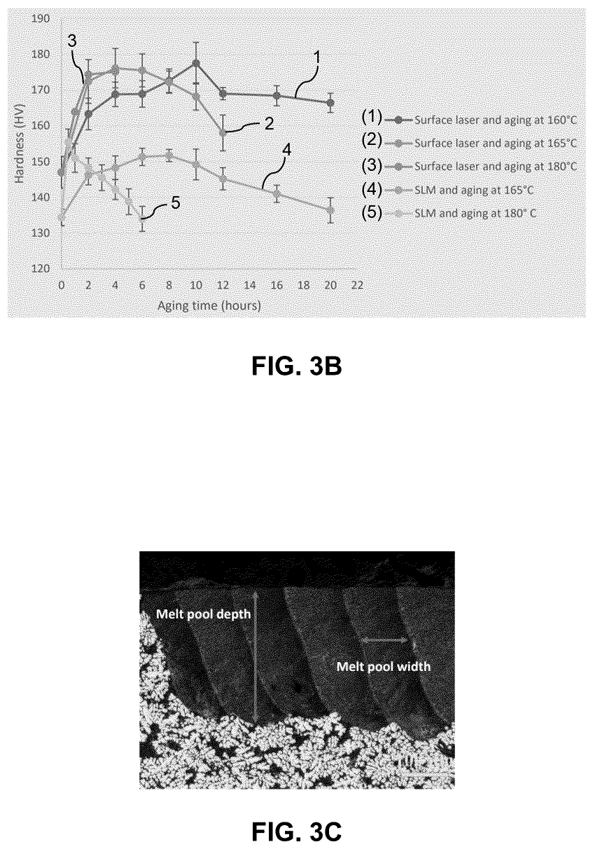

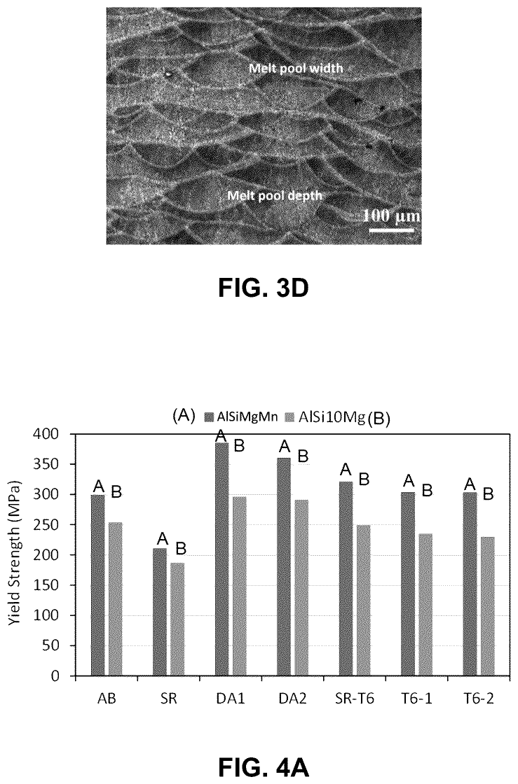

The hardness was measured after a surface laser scan on the surface of cast plates (FIG. 3A) or SLM where tensile test coupons were built from gas atomized powder followed by aging at 160° C., 165° C., or 180° C. (T5 direct ageing). The hardness testing results in FIG. 3B show that laser scanning on the surfaces of cast plates gave a higher hardness and different age hardening kinetics compared to samples built from powder in the full SLM trial. Comparisons were made by hardness testing because the melt pools from the laser scanning trials were too small to enable mechanical property determination by tensile testing. Evidently, the conditions in the laser scan trials are different from those where samples are printed directly from powder by SLM. The laser scanning is not a form of AM with layer-by-layer deposition, and there are clear microstructural differences between the laser scanning and the SLM as illustrated in FIGS. 3C-3D and in Table 4. FIGS. 3C-3D show AlSiMgMn melt pools from the laser scan trials where surface laser remelting was conducted on cast plates (FIG. 3C), compared to the SLM trials where tensile coupons were built up layer-wise from gas atomized powder (FIG. 3D). The laser scan trials required the use of a much lower laser scan speed of 700 mm/s (i.e. higher energy density of VED_ii=135.5 J/mm³) to compensate for the much higher degree of laser energy reflection from the solid cast surface than from powder. As a result, the most meaningful results in this invention come from the full SLM trial, where the same post-SLM heat treatments (Table 5) were applied to both AlSiMgMn and the standard AlSi10Mg alloy.

TABLE 4
Melt pool characteristics

| | |
|---|---|
| Surface laser remelting | SLM |

| | | | | |
|---|---|---|---|---|
| Melt pool depth | 309 ± 8.7 | μm | 56.8 ± 16.7 | μm |
| Melt pool width | 122 ± 22 | μm | 128.4 ± 39.0 | μm |
| Melt pool area | 37698 | μm² | 7293 | μm² |

TABLE 5
Post-SLM heat treatment parameters that were used for the
tensile test coupons printed from both the AlSiMgMn and
the standard AlSi10Mg powders in the full SLM trials

| Label | Condition | Post-SLM heat treatment |
|---|---|---|
| AB | SLM, as-built | N/A |
| SR | SLM + stress relief | 2 h at 300° C. |
| DA1 | SLM + direct ageing to T5 | 8 h at 165° C. |
| DA2 | SLM + direct ageing to T5 | 0.5 h at 180° C. |
| SR-T6 | SLM + stress relief + T6 | 2 h at 300° C. → 0.5 at 530° |
| | | C. → WQ → 24 h at 20° C. → |
| | | 6 h at 165° C. |
| T6-1 | SLM + T6 | 0.5 at 530° C. → WQ → 24 h at |
| | | 20° C. → 6 h at 165° C. |
| T6-2 | SLM + T6 | 0.5 at 500° C. → WQ → 24 h at |
| | | 20° C. → 6 h at 165° C. |

In terms of the heat treatments shown in Table 5, T6-1 is a post-SLM T6 heat treatment for standard AlSi10Mg alloys. On the other hand, T6-2 is an alternative T6 treatment investigated herein for comparative purposes based on the hypothesis that a lower solution treatment temperature of ˜500° C. would prevent excessive coarsening of the eutectic particles. The direct ageing treatments to the T5 temper (DA1 and DA2) were chosen to correspond to the peak hardness based on the SLM results in FIG. 3B. The SR condition is known to be a stress relieving treatment of around 2 hours at ˜300° C. that can be applied to reduce distortions in components made by SLM. However, since the SR treatment is known to soften the material significantly, an SR-T6 treatment was investigated in this example for the purpose of hardening the material after the stress-relieving treatment. Note that all T6 heat treatments (SR-T6, T6-1 and T6-2) included an optional 24-hour natural ageing period (at ˜20° C.) between water quenching and the commencement of the ageing treatment of 6 hours at 165° C. For the directly aged samples (DA1 & DA2) the natural ageing time was much longer (around a few weeks).

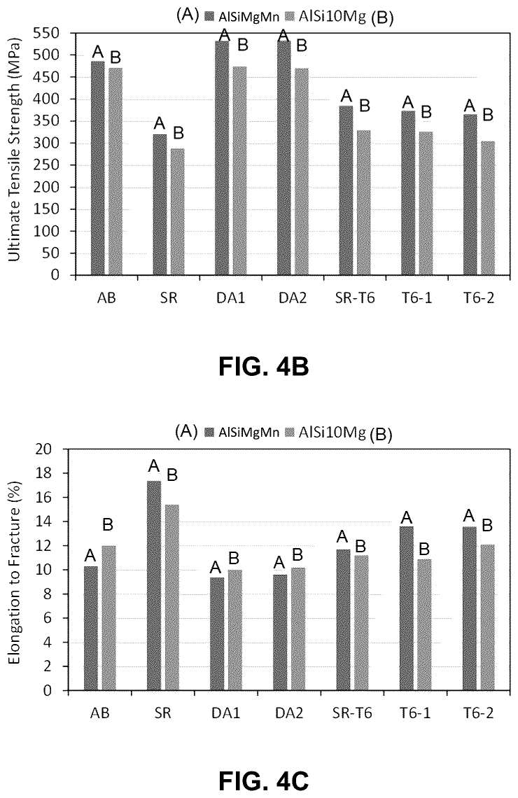

The tensile properties for all these post-SLM heat treatments are shown for both alloys in Table 6 and FIGS. 4A-4C. It is evident that AlSiMgMn achieved a significantly higher strength than the standard AlSi10Mg alloy for all the investigated heat treatment conditions, with up to ˜30% higher yield strengths in the T5 and T6 conditions. In both the SR and T6 conditions, all three tensile properties (YS, UTS and Elong.) of AlSiMgMn increased simultaneously over those of the standard AlSi10Mg. When looking at T6-1 and T6-2, the AlSiMgMn tensile properties were higher than those of AlSi10Mg by 29-32% for YS, by 15-20% for UTS and by 12-25% for elongation. AlSiMgMn achieved its highest strengths in the directly aged T5 conditions (361-386 MPa YS), followed by the SR-T6 condition (321 MPa YS) and then by the T6-1 and T6-2 conditions (304 MPa YS), all of which are very attractive when compared to the typical mechanical properties achieved by standard AlSi10Mg alloys after SLM (FIG. 1).

TABLE 6
Yield strength (YS), ultimate tensile strength (UTS) and elongation to fracture
(Elong.) based on tensile testing as a function of post-SLM heat treatments for
both the AlSiMgMn alloy and the standard AlSi10Mg from the full SLM trials

| Heat | AlSiMgMn | AlSiMgMn | AlSiMgMn | AlSi10Mg | AlSi10Mg | AlSi10Mg |
|---|---|---|---|---|---|---|
| treatment | YS (MPa) | UTS (MPa) | Elong. (%) | YS (MPa) | UTS (MPa) | Elong. (%) |
| AB | 299 | 486 | 10.3 | 254 | 471 | 12.0 |
| SR | 211 | 320 | 17.4 | 187 | 288 | 15.4 |
| DA1 | 386 | 532 | 9.4 | 296 | 474 | 10.0 |
| DA2 | 361 | 532 | 9.6 | 291 | 470 | 11.2 |
| SR-T6 | 321 | 384 | 11.7 | 249 | 329 | 10.9 |
| T6-1 | 304 | 373 | 13.6 | 235 | 326 | 12.1 |
| T6-2 | 304 | 365 | 13.6 | 230 | 305 | |

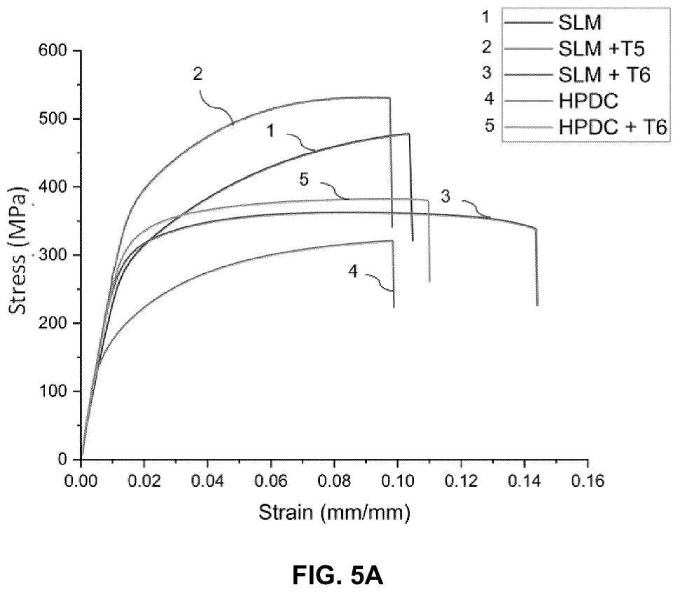

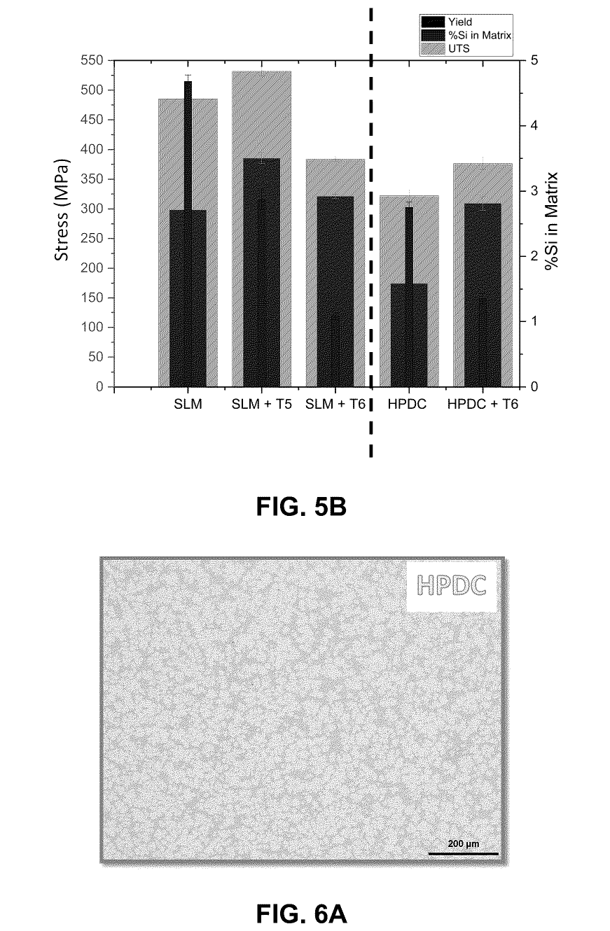

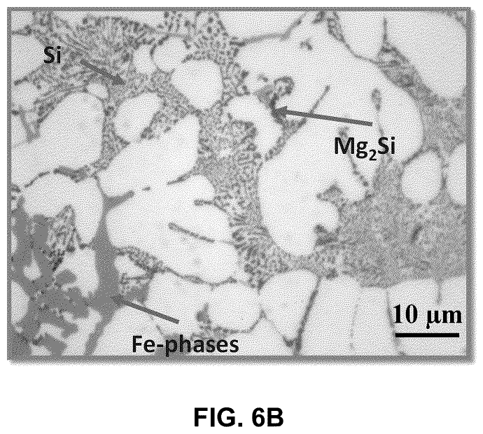

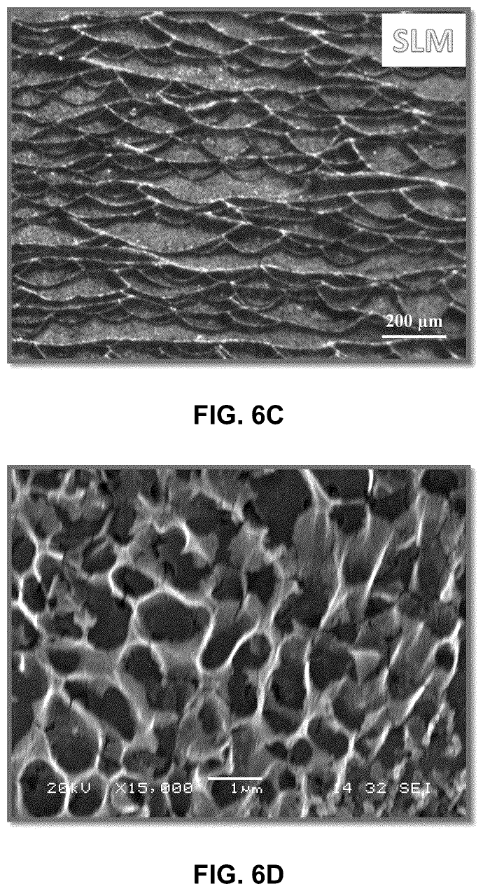

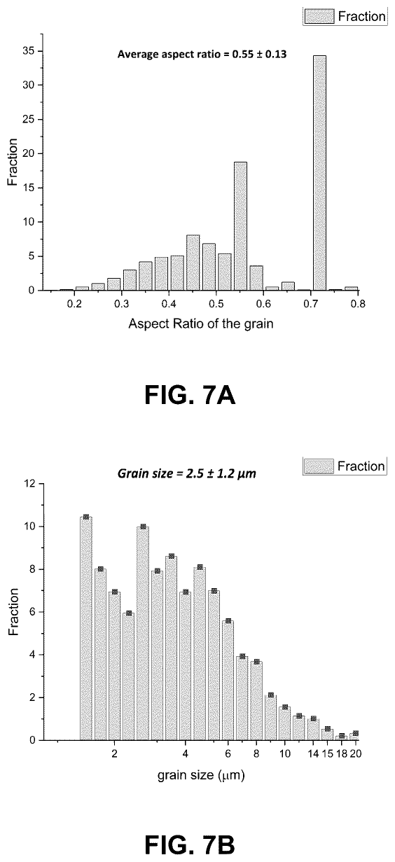

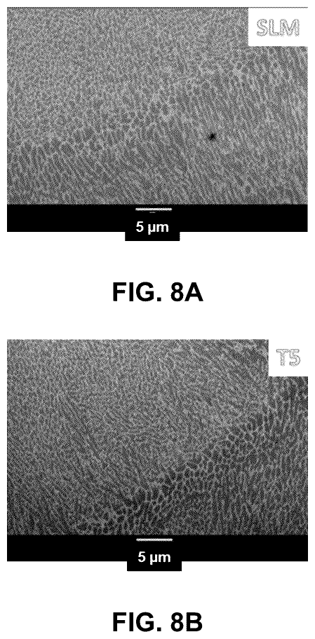

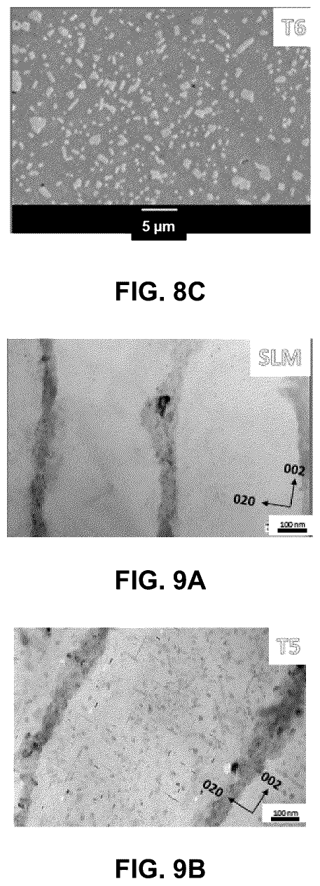

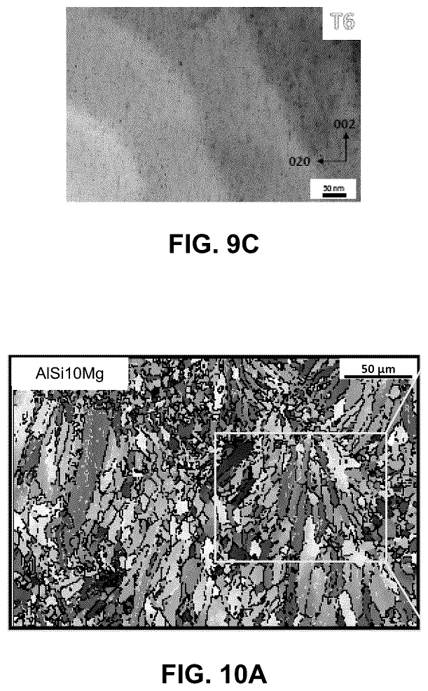

The mechanical properties and microstructure of AlSiMgMn was compared between SLM and high pressure vacuum die casting (HPVDC). The SLM was performed with 350 W laser power, 1650 mm/s laser speed, 130 μm hatch distance, and a 30 μm layer thickness. The conditions for the HPVDC were typical of the industry. SLM was followed by standard T5 and T6 treatments (DA1 and T6-1 respectively) whereas only T6 was performed on HPVDC. The resulting mechanical properties are shown in FIGS. 5A and 5B. SLM with T5 demonstrated the highest strength i.e. much higher than any HPDC result. In the T6 condition, SLM and HPDC exhibited similar strengths. The microstructure showed a separated Si eutectic in HPDC (FIGS. 6A-6B) whereas a connected and much finer Si eutectic network was observed after SLM in the as-manufactured condition (FIGS. 6C-6D). The grain size distribution of the as-manufactured condition for SLM is shown in FIGS. 7A-7B. The eutectic structure of SLM was also compared between the as-manufactured, T5 and T6 conditions (FIGS. 8A-8C). Si and MgSi precipitates were observed in the post-SLM T5 and T6 conditions (FIGS. 9A-9C).

Additional characterisation was performed on the AlSiMgMn (P2) and standard AlSi10Mg alloys shown in Table 2. The alloy compositions were labeled as AlSi10Mg0.5Mn and AlSi10Mg. The SLM was performed at a scan speed of 1650 mm/s, a laser power of 350 W, a powder layer thickness of 30 μm, a hatch distance of 130 μm, a laser spot size of 62 μm, an energy density of 54.4 J/mm³, and an adjacent layer rotation of 67°. Three conditions were evaluated: the “as-built” condition (AB), a directly aged T5 (165° C. for 8 h) and a T6 temperature treatment (300° C. for 2h; 530° C. for 0.5 h; water quench; and 165° C. for 6 h). The microstructure was evaluated by scanning electron microscopy (SEM), transmission electron microscopy (TEM), and electron backscatter diffraction (EBSD). The mechanical properties are shown in Table 6 and FIGS. 4A-4C.

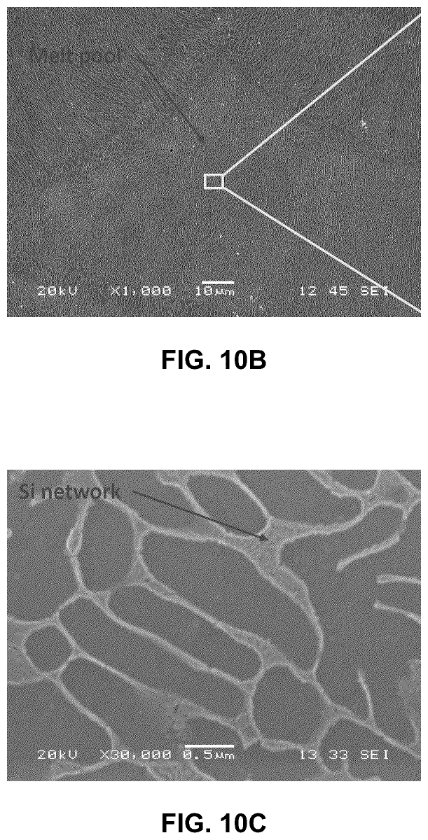

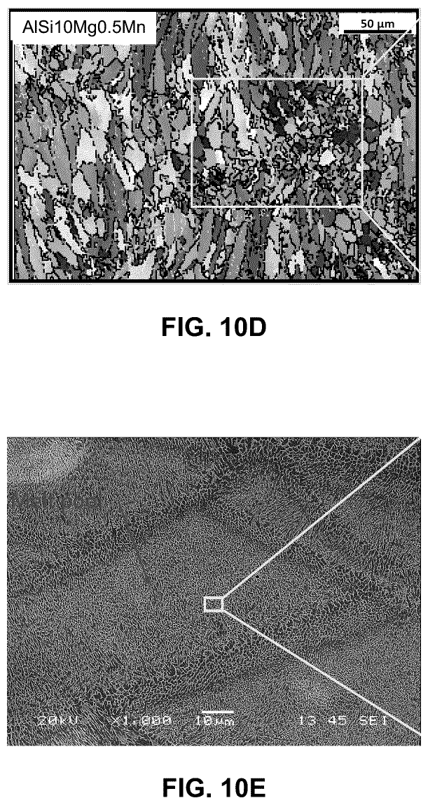

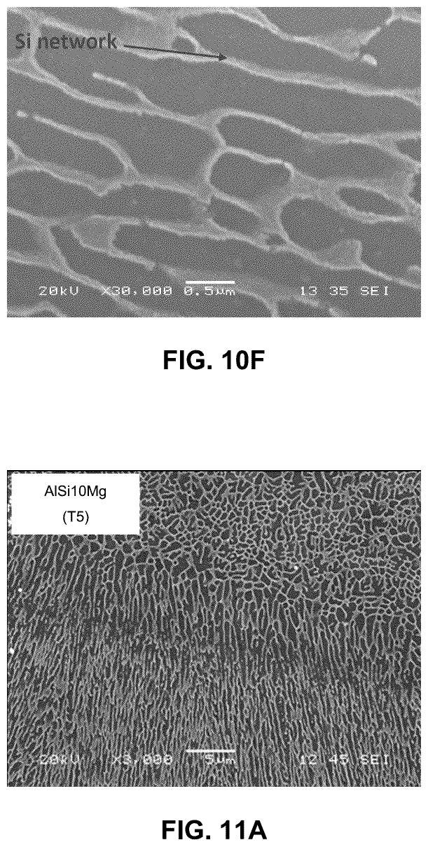

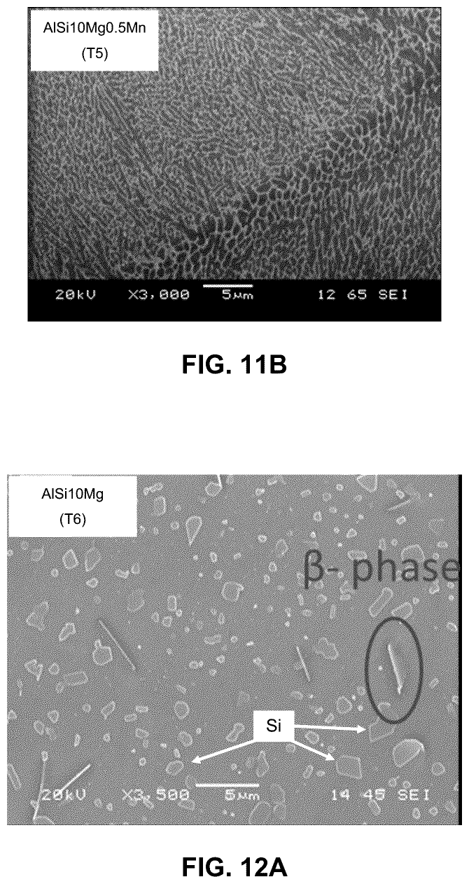

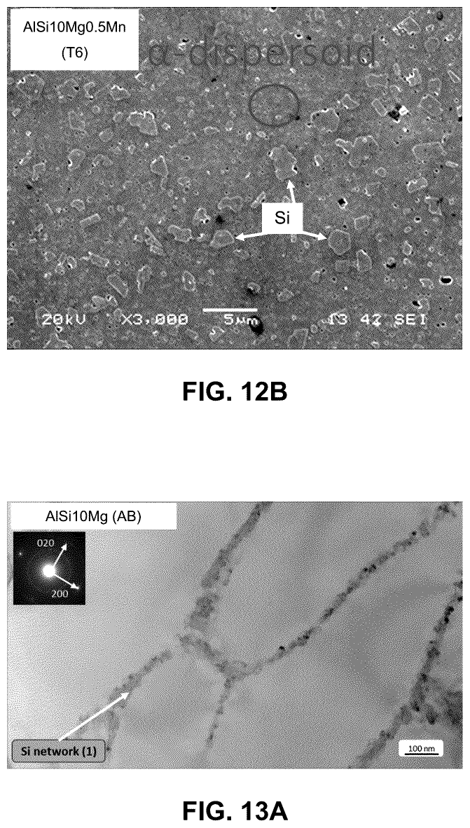

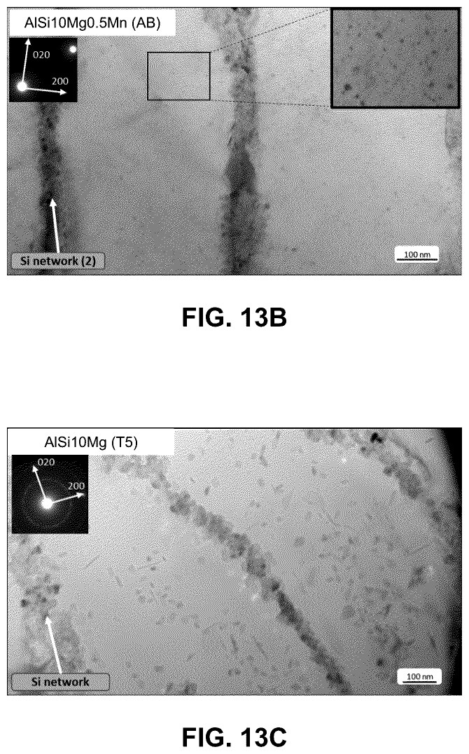

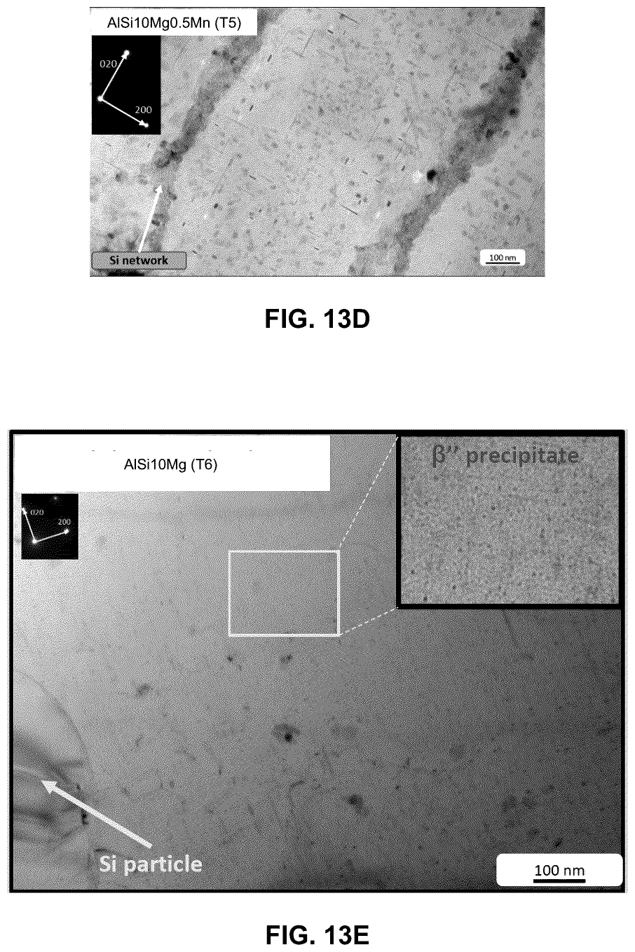

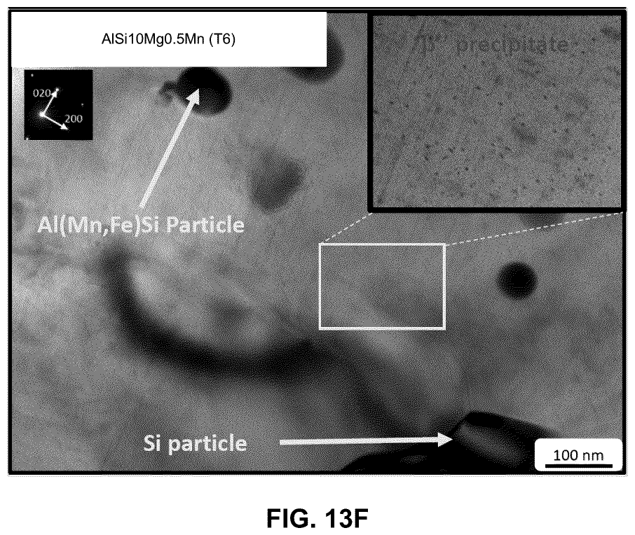

As shown in FIGS. 10A-10F, for both AlSi10Mg0.5Mn and AlSi10Mg the grain size, grain size distribution, melt pool size and Si network size were found to be similar when assessed as-manufactured. The microstructure of the alloys was further investigated by scanning electron microscopy (FIGS. 11A-11B and 12A-12B) and by transmission electron microscopy (FIGS. 13A-13F). It was found that in the as-built condition, the number of Si precipitates in the AlSi10Mg0.5Mn alloy was significantly superior to that of the AlSi10Mg alloy. It was also observed that the Si network composition was simple for the AlSi10Mg alloy whereas it was complex for the AlSi10Mg0.5Mn alloy. In the T5 condition, the fine eutectic Si network remained intact but a higher amount of Si and β″ Mg—Si hardening precipitates formed in the AlSi10Mg0.5Mn alloy than in the AlSi10Mg alloy. In the T6 condition, the AlSi10Mg alloy formed large elongated β-AlFeSi particles and the AlSi10Mg0.5Mn alloy formed small rounded α-Al(Mn,Fe)Si dispersoid particles as observed by both SEM and TEM (FIGS. 12A-12B and 13E-13F). The AlSi10Mg0.5Mn alloy demonstrated a superior yield strength in all conditions. In the as-built condition, the yield strength of the AlSi10Mg0.5Mn alloy was 299 MPa compared to 254 MPa for the AlSi10Mg alloy due to the presence of Si nano precipitates in the AlSi10Mg0.5Mn alloy as well as the different chemical composition of the Si network. In the T5 condition, the yield strength of the AlSi10Mg0.5Mn alloy was 386 MPa compared to 296 MPa for the AlSi10Mg alloy. In the T6 condition, due to the high temperature that the samples experienced, the Si network disappeared and the Si particles coarsened significantly in both alloys. The yield strength was 321 MPa for the AlSi10Mg0.5Mn alloy compared to 249 MPa for the AlSi10Mg alloy. The elongation of the AlSi10Mg0.5Mn alloy was also found to be superior due to the presence of the aforementioned small rounded alpha dispersoid particles instead of the large elongated beta particles.

According to the microstructure results, the fine and connected Si eutectic structure can be assumed to contribute to strengthening along with the extra effects of Si, Mg and Mn in solution and in precipitates. The fine and connected Si eutectic can tolerate a portion of load during the deformation and serve as a barrier for dislocation motion. The outstanding mechanical strengths of the T5 condition can be explained by a combination of the fine connected Si eutectic structure, solute in solution and nanosized hardening precipitates.

What is claimed is:

1. An additive manufacturing process comprising:
depositing layer by layer an aluminum alloy from powder or wire feedstock, the aluminum alloy comprising Si, Fe, Ti, 0.3-1 wt. % of Mn and 0.3-1 wt. % of Mg; and
performing a thermal consolidation to obtain a manufactured product.

2. The additive manufacturing process of claim 1, wherein the aluminum alloy further comprises 6 to 13 wt. % of Si.

3. The additive manufacturing process of claim 1, wherein the aluminum alloy further comprises 0.04-0.5 wt. % Fe.

4. The additive manufacturing process of claim 1, wherein the aluminum alloy further comprises less than or equal to 0.2 wt. % Ti.

5. The additive manufacturing process of claim 1, wherein thermal consolidation includes the melting of each layer as it is deposited by a laser to perform a laser powder bed fusion.

6. The additive manufacturing process of claim 1, further comprising heat treating the manufactured product.

7. The additive manufacturing process of claim 6, further comprising aging the manufactured product.

8. The additive manufacturing process of claim 7, wherein the heat treating is a T5 or a T6 treatment.

9. The additive manufacturing process of claim 8, wherein the T5 treatment is performed for 0.4 to 20 h at temperatures of 150 to 190° C.

10. The additive manufacturing process of claim 7, further comprising a stress relief treatment for 0.5-8 h at a temperature of 200-400° C.

11. The additive manufacturing process of claim 10, further comprising a T6 treatment comprising a first heat treatment at 450-600° C. for 0.1-10 h followed by a second heat treatment of 0.4 to 20 h at 150 to 190° C.

12. The additive manufacturing process of claim 11, wherein first the stress relief treatment is performed, then the T6 treatment.

13. The additive manufacturing process of claim 1, wherein the aluminum alloy is provided with the balance being aluminum and inevitable impurities, and the total inevitable impurities is less than or equal to 0.30 wt. %.

14. The additive manufacturing process of claim 1, wherein the aluminum alloy comprises less than 0.1 wt. % Cu.

15. The additive manufacturing process of claim 1, wherein the aluminum alloy comprises less than 0.05 wt. % Ni.

16. The additive manufacturing process of claim 1, wherein the aluminum alloy comprises Si in the range of 9.5 to 11.5 wt. %.

17. The additive manufacturing process of claim 1, wherein the aluminum alloy comprises Mg in the range of 0.3 to 0.6 wt. %.

18. The additive manufacturing process of claim 1, wherein the aluminum alloy comprises Mn in the range of 0.3 to 0.6 wt. %.

19. The additive manufacturing process of claim 11, wherein the T6 treatment further comprises a cooling step between the first heat treatment and the second heat treatment.

20. The additive manufacturing process of claim 19, wherein the cooling step is a water quench.
